(19) United States
(12) Patent Application Publication
(10) Pub. No.: US 2005/0194834 A1
(43) Pub. Date: Sep. 8, 2005

(54) Bicycle spoke fixture assembly

(76) Inventor: Chun-Hsung Chen, Taichung Hsien (TW)

Correspondence Address: BIRCH STEWART KOLASCH & BIRCH, PO BOX 747, FALLS CHURCH, VA, 22040-0747, US

(21) Appl. No.: 10/790,729

(22) Filed: Mar. 3, 2004

(51) Int. Cl. B60B 21/06

(52) U.S. Cl. 301/58

(57) ABSTRACT

A bicycle spoke fixture assembly is provided. The bicycle spoke fixture assembly includes a cushion member being placed in a space of the hole on the wheel wall allowing the spoke to pass through to latch, and a locking member passing through a through hole at the periphery of the hub and connecting the threaded section of the spoke. The A bicycle spoke fixture assembly makes the assembly and disassembly of a spoke quickly, and also enhances the strength of the wheel.

### FIELD OF THE INVENTION

The present invention relates to a bicycle spoke fixture assembly, and more particularly to a fixture assembly with spokes passing through a hole on a wheel rim and latching to a cushion member, such that this end of the spoke is secured to a locking member disposed at a hole along the periphery of a hub.

### BACKGROUND OF THE INVENTION

Please refer to FIG. 1 for a connecting structure that connects bicycle spokes to a hub. The spoke 1 has a threaded section 2 on a first end, and a screw head 3 on a second end. The spoke 1 is passed through a spoke hole 5 on the periphery of a bicycle hub 4. Since the screw head 3 is larger than the external diameter of the spoke 1, therefore the screw head 3 is clipped into the inner periphery of the spoke hole 5 of the hub 4. The threaded section 2 at the first end of the spoke 1 is secured to an adjusting screw head 7 disposed at the inner edge of the hub 4, so that the spoke 1 is pulled with an appropriate tension for resisting the force produced by the wheel rim 6 when the bicycle is moving. However, when it is necessary to replace the prior-art spoke 1 structure, the used spoke 1 must be cut first in order to remove the used spoke 1. Most importantly, it is very difficult to install a new spoke 1, mainly because it is difficult to pass the spoke 1 slantingly outward through the spoke hole 5 of the hub 4, and installation is limited by the wheel axle transversally passing through the center of the bicycle hub 4. The process is time-consuming and laborious. Further, since the adjusting screw head 7 for securing the spoke 1 is disposed on the wheel rim 6, the angle of each adjusting screw head 7 is different, and users must rotate the wheel rim 6 to secure one adjusting screw head 7 before removing the spoke 1 by a screwdriver, which is very inconvenient.

### SUMMARY OF THE INVENTION

The primary objective of the present invention is to provide a bicycle spoke fixture assembly. The assembling method of the present invention is to pass a spoke through a spoke hole into a hub at the center of the wheel, and lock the spoke at the periphery of the hub. The locking member adjusts to pull the spoke taught, which is easy and convenient to assemble/disassemble.

Another objective of the present invention is to provide a bicycle spoke fixture assembly, which has a circular space in the wheel for accommodating a plurality of cushion members, and passing the cushion members through the space. Such an arrangement not only latches a screw head at one end of the spoke, but also enhances the strength of the wheel.

### BRIEF DESCRIPTION OF THE DRAWINGS

FIG. 1 is an illustrative view of a prior-art connecting structure for connecting a bicycle spoke with a wheel.

FIG. 2 is an exploded view of the bicycle spoke fixture assembly according to a preferred embodiment of the present invention.

FIG. 3A is a cross-sectional view of the bicycle spoke fixture assembly according to a preferred embodiment of the present invention.

FIG. 3B is a view of the details as depicted in FIG. 3A.

FIG. 4 is a planar view of the bicycle spoke fixture assembly according to a preferred embodiment of the present invention.

### DETAILED DESCRIPTION OF THE PREFERRED EMBODIMENTS

To make it easier for our examiner to understand the objectives of the invention, its structure, innovative features, and performance, we use a preferred embodiment together with the attached drawings for the detailed description of the invention.

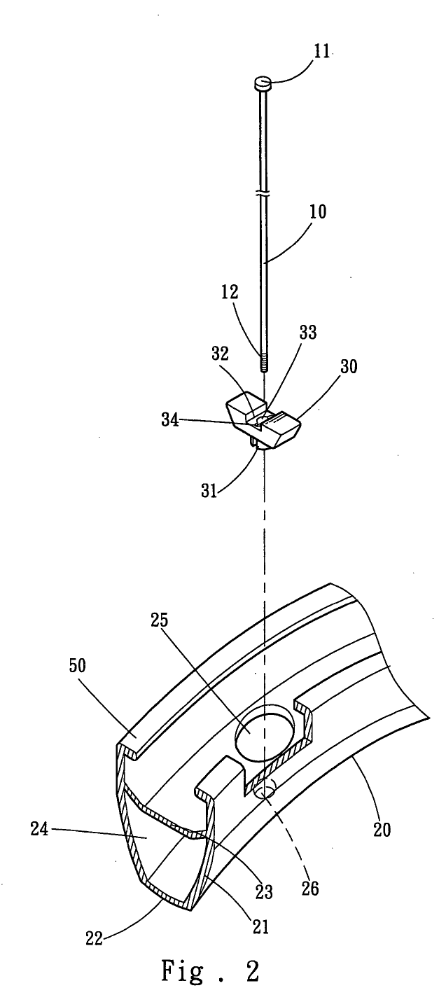

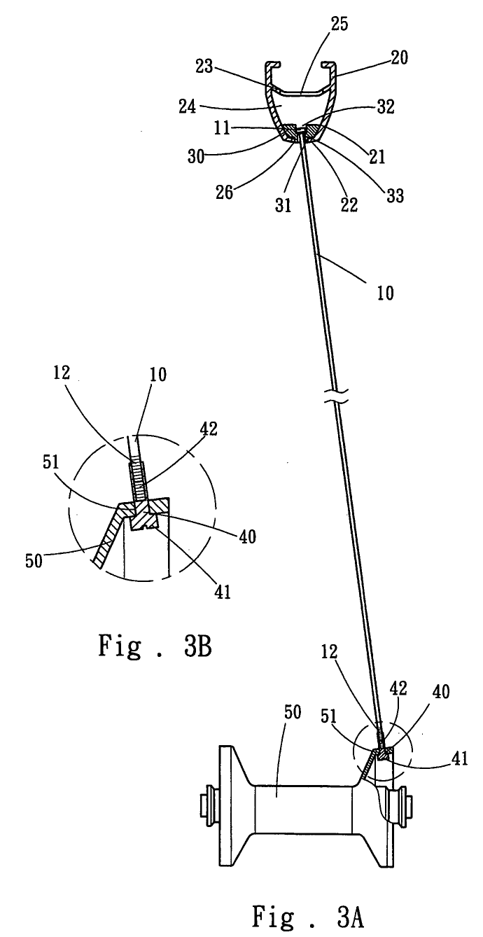

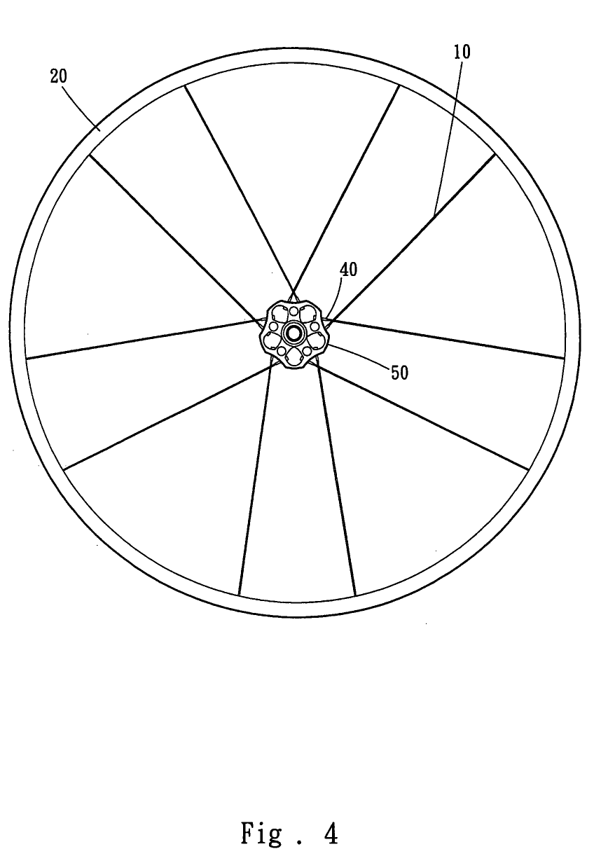

Please refer to FIGS. 2 and 3A for the bicycle spoke fixture assembly according to the present invention, comprising a metal spoke 10, a screw head 11 being disposed at a first end of the spoke 10 and larger than the external diameter of the spoke 10, and a threaded section 12 being disposed at a second end of the spoke 10;
a wheel rim 20, having two circular walls 21 symmetrically on the left and right sides, a bottom wall 22 of the two circular walls 21 coupled to the inner edge of the wheel rim 20, a wheel wall 23 of the two circular walls 21 transversally coupled to the middle of the wheel rim 20, such that the two wheel walls 21, bottom wall 22, and wheel wall 23 encloses a circular space 24 at the inner ring of the wheel rim 20, and a hole being disposed at an appropriate distance on the wheel wall 23, and a spoke hole 26 being smaller than the hole 25 and corresponding to the hole 26, and the space 24 at the cross section of the wheel has a V-shaped bottom;
a cushion member 30, being substantially in a trapezium shape and corresponding to the bottom of the space 24 of the wheel rim 20, and two corresponding semi-circular positioning pillars 31 being extended from the bottom and latching into the spoke hole 26 at the bottom wall 22 of the wheel rim 20, and the cushion member 30 at the front and rear of the top having an accommodating groove 32, and a positioning hole 33 disposed at the accommodating groove 32 and being vertically interconnected, and a long groove 34 being extended from both sides of the accommodating groove 32 and interconnected with the positioning hole 33, and the long groove 34 passing through the upper and lower sides of the cushion member 30 for receiving another type of flat spoke 20;
a locking member 40, being in a cylindrical shape (as shown in FIG. 3B) and having a screw head 41 at one end for a screwdriver or a wrench to rotate the locking member 40, and a screw hole 42 on the other end of the locking member 40, and after the locking member 40 passes through the through hole 51 disposed on the periphery of a hub 50 and the screw head 41 being latched, another screw hole 42 of the locking member 40 being locked into the threaded section 12 of the spoke 10, so that the spoke 10 couples to the wheel rim 20 with the hub 50 as shown in FIG. 4.

By means of the foregoing structures, the cushion member 30 is vertically disposed in the space 24 of the hole 25 on the wheel wall 23 when the spoke 10 is assembled to match the two circular walls 21 of the space 24 to restrict the cushion member 30 from rotating and moving freely, and the positioning pillar 31 of the cushion member 30 is mounted precisely into the spoke hole 26 of the wheel rim 20, and then the spoke 10 passes through the hole 25 on the wheel wall 23 of the wheel rim 20, so that the screw head 11 of the spoke 10 is clipped at the outer wall of the positioning hole 33 and disposed in the accommodating groove 32, and the threaded section 12 of the spoke 10 is inserted into the locking member 40 on the hub 50 to lock with the screw hole 41 of the locking member 40 for pulling the spoke 10 and keeping the spoke 20 at a specific tension.

Since the cushion members 30 of the present invention are disposed in the circular space 24 of the wheel rim 20 to match the number of spokes 10, which is similarly to general ribs for enhancing the strength of the wheel rim 20.

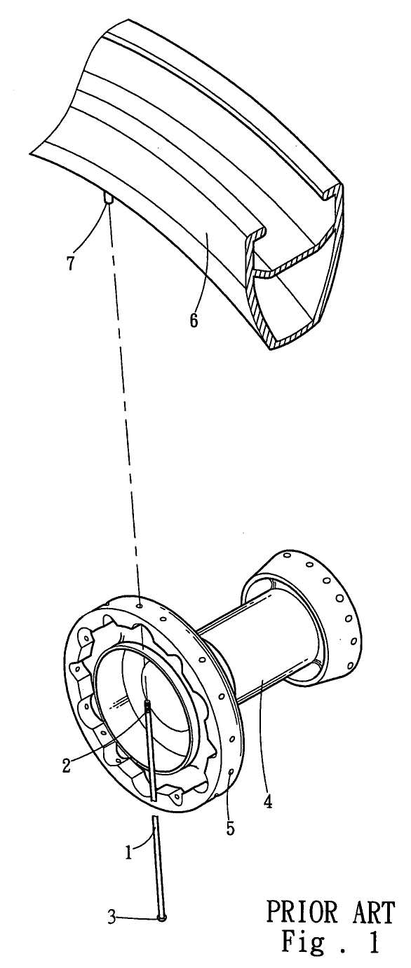

Most importantly, the spokes 10 of the present invention are passed through the holes 25 disposed on the outer periphery of the wheel wall 23 of the wheel rim 20 into the hub 50 and then secured to a locking member 40 on the hub 50. Since the position for adjusting the tightness of the spokes 10 are at the periphery of the hub 50, it is obviously used for adjusting and concentrating all spokes 10 to the periphery of the hub 50. Unlike the traditional bicycle wheel rim 6 as shown in FIG. 1, the present invention allows users to tighten all locking members 40 one at a time without requiring users to rotate the wheel rim 20 from time to time to adjust the locking angle and directions.

If it is necessary to replace a spoke 10, the users insert the spoke 10 from the outer periphery of the wheel rim 20 and pass the spoke 10 through the hole 25, the spoke hole 26 of the wheel rim 20, and then lock the spoke 10 to the locking member 40 on the hub 50. Since there is no other component on the outer periphery of the wheel rim 20, the user has enough working space to pass the spoke 10 and connect the spoke 10 with the wheel rim 20 and the hub 50 easily.

1. A bicycle spoke fixture assembly, comprising:
a metal spoke having a screw head at a first end and a threaded section at a second end;
a wheel rim including a right wall and a left wall, a bottom wall coupled to a bottom of said right wall and a bottom of said left wall, a wheel wall coupled to a point above said bottom of said right wall and a point above said bottom of said left wall, said right and said left walls, said bottom wall, and said wheel wall enclosing a space said wheel wall at least including a hole, said bottom wall at least including a spoke hole corresponding to said hole for receiving said spoke;
a cushion member placed in said space for passing and fixing said spoke, said cushion member including a main portion and a bottom portion, said bottom portion extending from said main portion into said spoke hole with said main portion being outside said spoke hole; and
a locking member on a periphery of a hub, said locking member including a through hole for securing said threaded section of said spoke.

2. The bicycle spoke fixture assembly of claim 1, wherein said space has a substantially V-shaped bottom, and said main portion is substantially in a trapezium shape corresponding to said bottom of said space, said main portion being disposed in said space.

3. The bicycle spoke fixture assembly of claim 1, wherein said bottom portion comprises two semi-circular arc positioning pillars extended from said main portion into said spoke hole an accommodating groove disposed at the top of said cushion member, and a positioning hole disposed in the middle of said accommodating groove.

4. The bicycle spoke fixture assembly of claim 3, wherein said positioning hole comprises a long groove.

5. The bicycle spoke fixture assembly of claim 1, wherein a perimeter of said main portion is larger than a perimeter of said bottom portion.

6. The bicycle spoke fixture assembly of claim 6, wherein said cushion member has a T shape.

7. A bicycle spoke fixture assembly, comprising:
a metal spoke having a screw head at a first end and a threaded section at a second end;
a wheel rim including a right wall and a left wall, a bottom wall coupled to a bottom of said right wall and a bottom of said left wall, a wheel wall coupled to a point above said bottom of said right wall and a point above said bottom of said left wall, said right and said left walls, said bottom wall, and said wheel wall enclosing a space, said wheel wall at least including a hole, said bottom wall at least including a spoke hole corresponding to said hole for receiving said spoke;
a cushion member placed in said space and latched into said spoke hole for passing and fixing said spoke, said cushion member comprising two semi-circular arc positioning pillars extended into said spoke hole; and
a locking member on a periphery of a hub, said locking member including a through hole for securing said threaded section of said spoke.

8. The bicycle spoke fixture assembly of claim 7, wherein said space has a substantially V-shaped bottom, and said cushion member has a main portion, said main portion being substantially in a trapezium shape corresponding to said bottom of said space, said main portion being disposed in said space.

9. The bicycle spoke fixture assembly of claim 7, wherein said cushion member further comprises an accommodating groove disposed at the top of said cushion member, and a positioning hole disposed in the middle of said accommodating groove.

10. The bicycle spoke fixture assembly of claim 9, wherein said positioning hole comprises a long groove.
